(19) United States
(12) Patent Application Publication
(10) Pub. No.: US 2026/0253172 A1
(43) Pub. Date: Aug. 27, 2026

(54) IMAGE SCALING PROCESSING METHOD AND APPARATUS, TERMINAL, AND STORAGE MEDIUM

(71) Applicant: GravityXR Electronics and Technology Co. Ltd., Ningbo (CN)

(72) Inventors: Changqing LI, Ningbo (CN); Jiayan Zhuang, Ningbo (CN); Jiayun Chen, Ningbo (CN); Dezhi Zhu, Ningbo (CN); Zhongfeng Li, Ningbo (CN); Rui Zhang, Ningbo (CN); Chaohao Wang, Ningbo (CN); Xiaoyao QI, Ningbo (CN)

(21) Appl. No.: 19/576,998

(22) Filed: Mar. 24, 2026

Related U.S. Application Data
(63) Continuation-in-part of application No. PCT/CN2024/121136, filed on Sep. 25, 2024.

(30) Foreign Application Priority Data
Sep. 25, 2023 (CN) 202311246202.X
Sep. 25, 2023 (CN) 202311249554.0

(51) Int. Cl. G06T 3/4046; G06T 3/403; G06T 5/60; G06T 5/70; G06T 5/73; G06T 7/73; G06T 9/00

(52) U.S. Cl. CPC G06T 3/4046; G06T 3/403; G06T 5/60; G06T 5/70; G06T 5/73; G06T 7/73; G06T 9/002; G06T 2207/20016; G06T 2207/20021; G06T 2207/20081; G06T 2207/20084; G06T 2207/20192

(57) ABSTRACT

The present disclosure discloses an image scaling processing method and apparatus, a terminal, a storage medium, a computer program product, and a computer program. The method includes: acquiring eye movement information generated when a user observes a target image; performing a coordinate conversion on the eye movement information to obtain central coordinates corresponding to the eye movement information; determining a non-gaze region of the target image according to the central coordinates, and performing compression on the non-gaze region of the target image to obtain a compressed target image; performing a computation on the compressed target image to obtain a processed target image; and finally obtaining a decompressed target image according to the central coordinates and the processed target image. The present disclosure mainly saves storage bandwidth and computing hardware resources through compression, effectively reducing hardware resource requirements while ensuring an image effect of a gaze point region.

### CROSS-REFERENCE TO RELATED APPLICATIONS

This application is a continuation of, and claims benefit to, International Application No. PCT/CN2024/121136, filed on Sep. 25, 2024, which claims priority to Chinese Patent Application No. 202311249554.0, filed on Sep. 25, 2023 and Chinese Patent Application No. 202311246202.X, filed on Sep. 25, 2023. All of the aforementioned patent applications are hereby incorporated by reference in their entireties.

### TECHNICAL FIELD

The present disclosure relates to the field of computer technology, and in particular, to an image scaling processing method and apparatus, a terminal, and a storage medium.

### BACKGROUND

In computer image processing and computer graphics, image scaling refers to a process of adjusting a size of a digital image. Image scaling is a non-trivial process that requires a trade-off between processing efficiency and smoothness and clarity of a result. When a size of an image is increased, visibility of pixels composing the image will become higher, thus making the image appear “soft”. Conversely, reducing the size of the image will enhance the smoothness and clarity thereof.

Currently, a deep learning approach is generally adopted for scaling a target image.

However, the above-mentioned method suffers from a problem of image quality degradation, which results in poor scaling performance.

### SUMMARY

The main purpose of the present disclosure is to provide an image scaling processing method and apparatus, a terminal, a storage medium, a computer program product, and a computer program, so as to solve the problem of image quality degradation existing in the related art.

To achieve the above-mentioned purpose, in a first aspect, the present disclosure provides an image scaling processing method, including:
acquiring eye movement information generated when a user observes a target image;
performing a coordinate conversion on the eye movement information to obtain central coordinates corresponding to the eye movement information;
determining a non-gaze region of the target image according to the central coordinates, and performing compression on the non-gaze region of the target image to obtain a compressed target image;
performing a computation on the compressed target image to obtain a processed target image; and
obtaining a decompressed target image according to the central coordinates and the processed target image.

In a possible implementation, the determining a non-gaze region of the target image according to the central coordinates, and performing compression on the non-gaze region of the target image to obtain a compressed target image includes:
determining coordinates of respective regions in the non-gaze region of the target image according to the central coordinates, where coordinates of respective regions in the target image include the central coordinates and the coordinates of the respective regions in the non-gaze region; and
performing compression processing on the target image based on the coordinates of the respective regions in the target image to obtain the compressed target image.

In a possible implementation, the target image further includes a gaze region, and the method further includes:
determining coordinates of respective regions in the gaze region of the target image according to the central coordinates, where the coordinates of the respective regions in the target image further include the coordinates of the respective regions in the gaze region, and the gaze region includes a transition region located at an edge; and performing compression processing on the target image based on the coordinates of the respective regions in the target image to obtain the compressed target image.

In a possible implementation, the performing the compression processing on the target image based on the coordinates of the respective regions in the target image to obtain the compressed target image includes:
determining a coordinate mapping table of the non-gaze region based on the coordinates of the respective regions in the non-gaze region of the target image;
performing a table lookup according to the gaze region, the central coordinates, the non-gaze region, and the coordinate mapping table, and calculating mapping coordinates and a scaling ratio of each pixel point position in the target image;
calculating, according to the scaling ratio, a scaling weight of the gaze region, a scaling weight of the non-gaze region, and a fusion weight of the transition region in the target image, where a continuous ratio scaling curve corresponding to the scaling weight of the non-gaze region is a first derivative-smoothed curve, a point on the first derivative-smoothed curve is used to represent a scaling ratio at a pixel coordinate position, and the scaling ratio increases progressively;
a transition fusion weight curve corresponding to the fusion weight is a second derivative-smoothed curve, a point on the second derivative-smoothed curve is used to represent a transition fusion weight of a distance between a pixel position and the edge of the gaze region, the transition fusion weight integrates an interpolation curve weight and an identity mapping weight, and an interpolation curve weight of a pixel position close to an edge position of the gaze region is higher, while an identity mapping weight of a pixel position close to a center of the gaze region is higher; and
performing weighted synthesis on the scaling weight of the gaze region, the scaling weight of the non-gaze region, and the fusion weight of the transition region, and outputting the compressed target image.

In a possible implementation, an image algorithm operation used for the computation processing performed on the compressed target image includes at least one of: an operation of a denoising algorithm, or a specific image algorithm operation.

In a possible implementation, the denoising algorithm is a neural network algorithm;
the performing computation processing on the compressed target image to obtain a processed target image includes:
performing denoising processing on the compressed target image by using the neural network algorithm to obtain the processed target image.

In a possible implementation, the obtaining a decompressed target image according to the central coordinates and the processed target image includes:
calculating coordinates of respective regions in the processed target image according to the central coordinates; and
performing decompression processing on the processed target image based on the coordinates of the respective regions in the processed target image to obtain the decompressed target image.

In a possible implementation, the central coordinates refer to a position corresponding to a gaze region of the target image;
the calculating coordinates of respective regions in the processed target image according to the central coordinates includes:
determining coordinates of respective regions in a non-gaze region of the processed target image according to the central coordinates, where the coordinates of the respective regions in the processed target image include the central coordinates and the coordinates of the respective regions in the non-gaze region.

In a possible implementation, the performing decompression processing on the processed target image based on the coordinates of the respective regions in the processed target image to obtain the decompressed target image includes:
determining a coordinate mapping table of the non-gaze region based on the coordinates of the respective regions in the non-gaze region of the processed target image;
performing a reverse table lookup according to the gaze region, the central coordinates, the non-gaze region and the coordinate mapping table, and calculating mapping coordinates and a scaling ratio of each pixel point position in the processed target image;
calculating, according to the scaling ratio, a scaling weight of a gaze region, a scaling weight of the non-gaze region and a fusion weight of a transition region in the processed target image; and
performing weighted synthesis on the scaling weight of the gaze region, the scaling weight of the non-gaze region, and the fusion weight of the transition region, and outputting the decompressed target image.

In a possible implementation, the central coordinates refer to a position corresponding to a gaze region of the target image or a position corresponding to a gaze point set on the target image.

In a possible implementation, the gaze point is dynamic information obtained according to eye tracking, or a static gaze point unaffected by the eye movement information.

In a possible implementation, the target image includes at least one of: a Bayer image, an RGB image, a RAW image, or a YUV image.

In a possible implementation, a computation method for performing the computation on the compressed target image includes at least one of: neural processing unit (NPU) computation, or neural network model computation.

In a possible implementation, the target image further includes a gaze region, and the method further includes:
determining, according to the central coordinates, the gaze region and the non-gaze region of the target image;
determining a first sampling rate for the gaze region and a second sampling rate for the non-gaze region, where the first sampling rate is greater than the second sampling rate;
performing sampling processing on the gaze region and the non-gaze region respectively based on the first sampling rate and the second sampling rate to obtain a sampled image; and
determining a first compression rate and a second compression rate of the sampled image, and performing compression processing on the gaze region and the non-gaze region of the sampled image based on the first compression rate and the second compression rate to obtain a target compressed image.

In a possible implementation, the determining, according to the central coordinates, the gaze region and the non-gaze region of the target image includes:
dividing the target image in a horizontal direction and a vertical direction based on the central coordinates to obtain N*M image units;
determining the gaze region based on the central coordinates, where the gaze region includes X*Y image units, with 1≤X≤N and 1≤Y≤M; and
determining remaining regions of the target image as the non-gaze region.

In a possible implementation, the performing sampling processing on the gaze region and the non-gaze region respectively based on the first sampling rate and the second sampling rate to obtain a sampled image includes:
acquiring a horizontal coordinate and a vertical coordinate of the target image, and determining, based on the horizontal coordinate and the vertical coordinate of the target image as well as the central coordinates, an initial sampling position and a step distance;
setting a data window and sampling points, and determining a movement parameter of the data window based on the sampling points; and
performing sampling on the gaze region and the non-gaze region based on the movement parameter, the initial sampling position, and the step distance, to obtain the sampled image.

In a possible implementation, the setting a data window and sampling points, and
determining a movement parameter of the data window based on the sampling points includes: determining a relative position of the data window and a first sampling point and/or a second sampling point; and
determining the movement parameter based on the relative position.

In a possible implementation, in the non-gaze region, sampling rates of image units located in a same horizontal direction are the same, and sampling rates of image units located in a same vertical direction are the same.

In a possible implementation, the determining a first sampling rate for the gaze region and a second sampling rate for the non-gaze region includes:
setting the first sampling rate for the gaze region, where the first sampling rate falls within a gaze compression range;
determining image distances between image units in the non-gaze region and the gaze region;
determining a plurality of second sub-sampling rates based on the second sampling rate, where sampling parameters of different second sub-sampling rates are different; and
configuring second sub-sampling rates corresponding to the image units in the non-gaze region based on the image distances, where a larger image distance corresponds to a smaller second sub-sampling rate.

In a possible implementation, the method further includes:
performing storage and/or decompression processing on the target compressed image based on the first compression rate and the second compression rate to obtain an output image.

In a second aspect, an embodiment of the present disclosure provides an image scaling processing apparatus, including:
an acquisition module, configured to acquire eye movement information generated when a user observes a target image;
a first computation module, configured to perform a coordinate conversion on the eye movement information to obtain central coordinates corresponding to the eye movement information;
a compression module, configured to determine a non-gaze region of the target image according to the central coordinates, and perform compression on the non-gaze region of the target image to obtain a compressed target image;
a second computation module, configured to perform a computation on the compressed target image to obtain a processed target image; and
a decompression module, configured to obtain a decompressed target image according to the central coordinates and the processed target image.

In a third aspect, an embodiment of the present disclosure provides a terminal, including: a memory, a processor, and a computer program stored in the memory and executable on the processor, where when the computer program is executed by the processor, steps of any one of the above image scaling processing methods are implemented.

In a fourth aspect, an embodiment of the present disclosure provides a computer-readable storage medium, the computer-readable storage medium storing a computer program, where when the computer program is executed by a processor, steps of any one of the above image scaling processing methods are implemented.

In a fifth aspect, an embodiment of the present disclosure provides a computer program product, the computer program product including: a computer program stored in a readable storage medium. At least one processor of an electronic device may read the computer program from the readable storage medium, and at least one processor executes the computer program to enable the electronic device to implement steps of any one of the above image scaling processing methods.

In a sixth aspect, an embodiment of the present disclosure provides a computer program, and the computer program is stored in a readable storage medium. At least one processor of an electronic device may read the computer program from the readable storage medium, and at least one processor executes the computer program to enable the electronic device to implement steps of any one of the above image scaling processing methods.

Embodiments of the present disclosure provide an image scaling processing method and apparatus, a terminal, and a storage medium, where the method includes: acquiring eye movement information generated when a user observes a target image; performing a coordinate conversion on the eye movement information to obtain central coordinates corresponding to the eye movement information; determining a non-gaze region of the target image according to the central coordinates, and performing compression on the non-gaze region of the target image to obtain a compressed target image; performing a computation on the compressed target image to obtain a processed target image; and finally obtaining a decompressed target image according to the central coordinates and the processed target image. The present disclosure scales the non-gaze region based on the central coordinates, making it necessary for a scaled image to be quickly restored to an original size after completion of NPU processing. This ensures that other spatial domain-related modules of an image signal processor (ISP) remain unaffected, prevents quality degradation of the target image, and enhances a scaling effect of the target image. Further, according to an exemplary embodiment of the disclosure, a gaze region of the target image may also be determined based on the central coordinates. By setting a sampling rate for the gaze region to be higher than a sampling rate for the non-gaze region, and a compression rate of the gaze region to be lower than a compression rate of the non-gaze region, a size of a compressed image can be reduced while ensuring image quality, effectively saving storage resources. The present disclosure mainly saves storage bandwidth and computing hardware resources through compression, effectively reducing hardware resource requirements while ensuring an image effect of a gaze point region.

### BRIEF DESCRIPTION OF DRAWINGS

The accompanying drawings, which form a part of the present disclosure, serve to provide a further understanding of the present disclosure and to make other features, purposes and advantages of the present disclosure more apparent. The accompanying drawings of the illustrative embodiments of the present disclosure and the descriptions thereof are used to explain the present disclosure and shall not constitute an improper limitation of the present disclosure. In the accompanying drawings:

FIG. 1 is a schematic diagram of image coordinate mapping provided by an embodiment of the present disclosure.

FIG. 2 is a schematic diagram of ratio setting for image partitions provided by an embodiment of the present disclosure.

FIG. 3 is an implementation flowchart of an image scaling processing method provided by an embodiment of the present disclosure.

FIG. 4 is an implementation flowchart of an image scaling processing method provided by another embodiment of the present disclosure.

FIG. 5 is an implementation flowchart of an image compression method provided by an embodiment of the present disclosure.

FIG. 6 is a schematic diagram of ratio setting for each region of an image provided by an embodiment of the present disclosure.

FIG. 7 is a schematic diagram of an RGB image format and a Bayer image format provided by an embodiment of the present disclosure.

FIG. 8 is a schematic diagram of another ratio setting for each region of an image provided by an embodiment of the present disclosure.

FIG. 9 is a diagram of a continuous ratio scaling curve provided by an embodiment of the present disclosure.

FIG. 10 is a diagram of a transition zone curve provided by an embodiment of the present disclosure.

FIG. 11 is an implementation flowchart of an image decompression method provided by an embodiment of the present disclosure.

FIG. 12 is an implementation flowchart of an image scaling processing method provided by another embodiment of the present disclosure.

FIG. 13 is an implementation flowchart of determining a gaze region and a non-gaze region of a target image provided by an embodiment of the present disclosure.

FIG. 14 is a schematic diagram of a gaze region and a non-gaze region provided by an embodiment of the present disclosure.

FIG. 15 is an implementation flowchart of determining a first sampling rate and a second sampling rate provided by an embodiment of the present disclosure.

FIG. 16 is a schematic diagram of configuring second sub-sampling rates for a non-gaze region provided by an embodiment of the present disclosure.

FIG. 17 is an implementation flowchart of performing sampling processing on a gaze region and a non-gaze region provided by an embodiment of the present disclosure.

FIG. 18 is a schematic structural diagram of an image scaling processing apparatus provided by an embodiment of the present disclosure.

FIG. 19 is a block diagram of an image scaling processing apparatus provided by another embodiment of the present disclosure.

FIG. 20 is a block diagram of an image scaling processing apparatus provided by another embodiment of the present disclosure.

FIG. 21 is a schematic diagram of a terminal provided by an embodiment of the present disclosure.

### DESCRIPTION OF EMBODIMENTS

To clarify the purposes, technical solutions, and advantages of the embodiments of the present disclosure, the technical solutions in the embodiments of the present disclosure will be described clearly and comprehensively below with reference to the accompanying drawings in the embodiments of the present disclosure. Apparently, the described embodiments are merely a part of the embodiments of the present disclosure, not all of them. Based on the embodiments of the present disclosure, all other embodiments obtained by those of ordinary skill in the art without creative labor are within the protection scope of the present disclosure.

The terms “first”, “second”, “third”, “fourth”, etc. (if present) in the specification, claims, and the accompanying drawings of the present disclosure are used to distinguish similar objects, and are not necessarily used to describe a specific order or a sequence. It should be understood that data used in this manner may be interchanged where appropriate, so that the embodiments of the present disclosure described herein can be implemented in an order other than those illustrated or described herein.

It should be understood that in the various embodiments of the present disclosure, magnitude of a sequence number of each process does not indicate priority of an execution order. The execution order of each process shall be determined based on a function and an inherent logic thereof, and shall not constitute any limitation on implementation processes of the embodiments of the present disclosure.

It should be understood that in the present disclosure, “comprising” and “having” and any variations thereof are intended to cover non-exclusive inclusions. For example, a process, a method, a system, a product, or a device that includes a series of steps or elements is not necessarily limited to those steps or elements explicitly listed, but may include other steps or elements that are not explicitly listed or are inherent to such process, method, product, or device.

It should be understood that in the present disclosure, “a plurality of” refers to two or more. “And/or” merely describes an association relationship between associated objects and indicates that three types of relationships may exist. For example, A and/or B may indicate three situations: presence of A only, presence of both A and B, and presence of B only. A character “/” generally indicates that associated objects before and after it are in an “or” relationship. “Including A, B and C” and “including A, B, C” mean that all three of A, B and C are included. “Including A, B or C” means that one of A, B and C is included. “Including A, B and/or C” means that any one, any two, or all three of A, B and C are included.

It should be understood that in the present disclosure, “B corresponding to A”, “B that corresponds to A”, “A corresponds to B”, or “B corresponds to A” indicates that B is associated with A, and B can be determined according to A. Determining B according to A does not mean that B can be determined solely according to A, but may also be determined according to A and/or other information. The matching between A and B is that the similarity between A and B is greater than or equal to a preset threshold.

Depending on the context, “if” as used herein may be interpreted as “when”, “at the time of”, “in response to determining” or “in response to detecting”.

Hereinafter, the technical solutions of the present disclosure will be described in detail with reference to specific embodiments. The specific embodiments described below may be combined with each other, and the same or similar concepts or processes may not be repeated in some embodiments.

Further, to clarify the purposes, technical solutions and advantages of the present disclosure, the following description will be provided through specific embodiments with reference to the accompanying drawings.

In computer image processing and computer graphics, image scaling refers to a process of adjusting a size of a digital image.

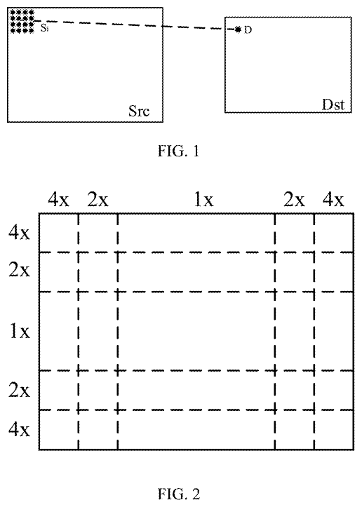

In the prior art, an image is mainly scaled by a Scaler method. As shown in FIG. 1, the method is essentially coordinate mapping, a corresponding point Si in a source image is found for a point D in a target image, and then interpolation is performed through an interpolation operation with an interpolation formula to obtain the target point D.

The Scaler method includes Scaler down and Scaler up. For an RGB image, Scaler down and Scaler up operations at different ratios are performed on the image mainly by partitioning. As shown in FIG. 2, the image is divided into a plurality of blocks, and different blocks are labeled with scaling ratios used by the blocks. For example, a first block at an upper left corner of the image is scaled with a ratio of 4.

However, the prior art suffers from a problem of image quality degradation, which results in poor scaling performance.

In an embodiment, as shown in FIG. 3, an image scaling processing method is provided, including following steps.

Step S301: acquiring eye movement information generated when a user observes a target image.

The eye movement information may be acquired by an eye movement device or other devices, and the eye movement information mainly includes the user's gaze position on a screen or an image, and a corresponding timestamp, etc.

Step S302: performing a coordinate conversion on the eye movement information to obtain central coordinates corresponding to the eye movement information.

The present disclosure mainly utilizes a microcontroller unit (MCU) to perform the coordinate conversion on the eye movement information. Through the conversion, the user's gaze position on the image, i.e., the central coordinates, can be acquired.

Step S303: determining a non-gaze region of the target image according to the central coordinates, and performing compression on the non-gaze region of the target image to obtain a compressed target image.

The target image includes images in various formats, including but not limited to images in Bayer, RAW, RGB and YUV formats.

Step S304: performing a computation on the compressed target image to obtain a processed target image.

Step S305: obtaining a decompressed target image according to the central coordinates and the processed target image.

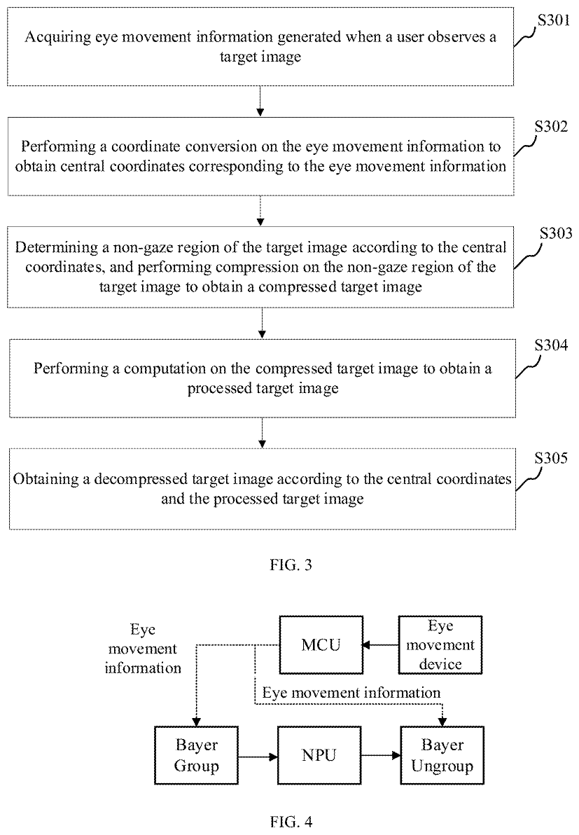

In conjunction with FIG. 4, taking the target image as a Bayer image for example, a compressed Bayer image obtained according to the central coordinates and the Bayer image is implemented by a Bayer Group module, while a decompressed Bayer image obtained according to the central coordinates and a processed Bayer image is implemented by a Bayer Ungroup module.

The process by which the Bayer Group module obtains the compressed Bayer image according to the central coordinates and the Bayer image is specifically described below. In conjunction with FIG. 5, main execution steps thereof are as follows: first, calculating coordinates of respective regions in the Bayer image according to the central coordinates; then, performing compression processing on the Bayer image based on the coordinates of the respective regions in the Bayer image to obtain the compressed Bayer image. The central coordinates refer to a position corresponding to a gaze region of the Bayer image.

The calculating coordinates of respective regions in the Bayer image based on the central coordinates requires that: coordinates of respective regions in a non-gaze region of the Bayer image are first determined based on the central coordinates; and then the central coordinates and the coordinates of the respective region in the non-gaze region constitute the coordinates of the respective regions in the Bayer image.

The performing compression processing on the Bayer image based on the coordinates of the respective regions in the Bayer image to obtain the compressed Bayer image requires that: a coordinate mapping table of the non-gaze region is first determined based on the coordinates of the respective regions in the non-gaze region of the Bayer image; then a table lookup is performed according to the gaze region, the central coordinates, the non-gaze region, and the coordinate mapping table, and mapping coordinates and a scaling ratio of each pixel point position in the Bayer image are calculated; furthermore, a scaling weight of the gaze region, a scaling weight of the non-gaze region, and a fusion weight of a transition region in the Bayer image are calculated according to the scaling ratio; and finally, weighted synthesis is performed on the scaling weight of the gaze region, the scaling weight of the non-gaze region, and the fusion weight of the transition region, and the compressed Bayer image is output.

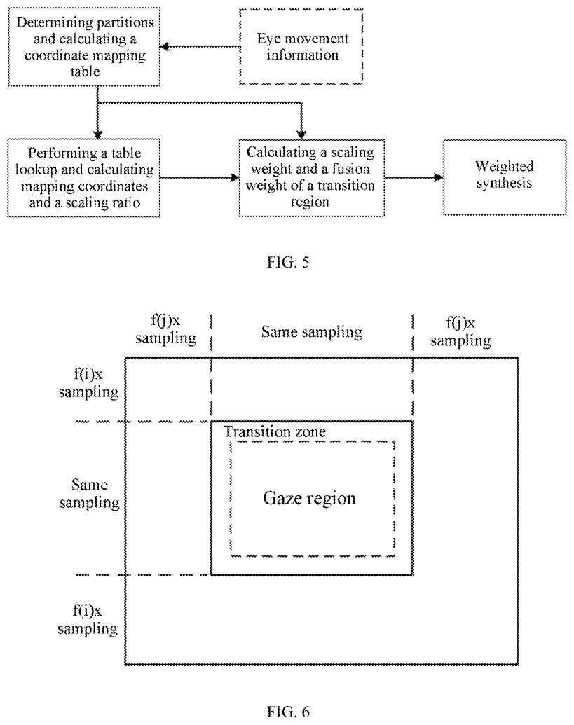

In conjunction with FIG. 6, the central coordinates refer to a position corresponding to the gaze region in the target image, and the gaze region is scaled at a fixed ratio. In addition, a transition zone is provided at an edge of the gaze region, and the transition zone ensures a natural transition of the image. A size of the gaze region may be adjusted as required.

The non-gaze region is outside the transition zone. The non-gaze region is divided into a plurality of blocks by lines, and each block is scaled at a variable ratio. The variable ratio is calculated by functions f(i) and f(j), and is related to a distance to the gaze region. The functions f(i) and f(j) are existing calculation functions, which are not specifically limited herein and may be set as required. For example, scaling of a first block at an upper left corner is performed using f(i)x sampling and f(j)x sampling, respectively.

In addition, the central coordinates may also be a position corresponding to a static gaze point set on the target image. This static gaze point is a point set on the target image by the user; and this point may be set according to user requirements, which is not specifically limited herein.

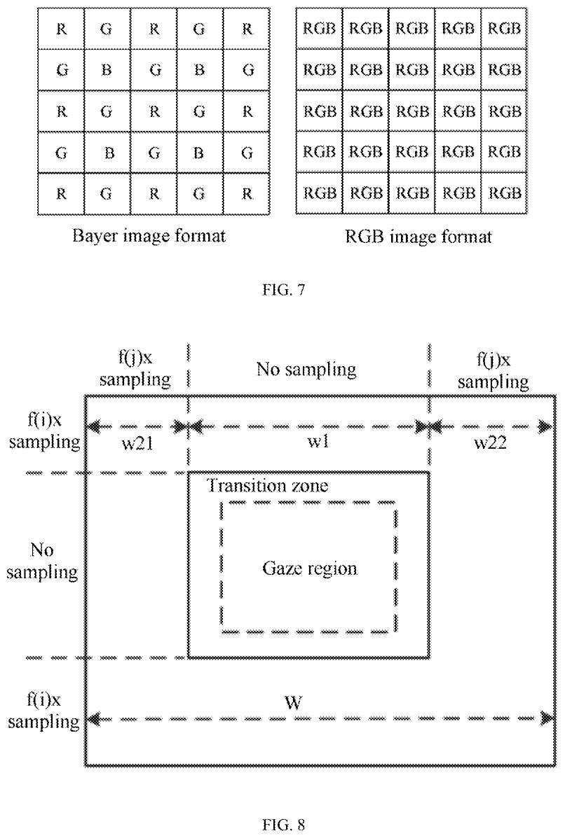

Taking the target image as a Bayer image, the Bayer image format inherently suffers from resolution loss compared to the RGB image format. When resampling is performed, assuming that a position where the target image is mapped to a source image is near a central box of the Bayer image in FIG. 7, there are 9 available values for calculating an R-channel value, 12 available values for a G-channel, and 4 available values for a B-channel within a 5×5 neighborhood of the Bayer image. Assuming that the position where the target image is mapped to the source image is near a central box of the RGB image in FIG. 7, each of the three RGB channels has 25 available values in an RGB domain.

In conjunction with FIG. 8 and FIG. 9, when the gaze region moves, since scaling ratios of other regions are correlated with distances to the gaze region, a scaling ratio look-up table is designed according to an image size and an overall scaling ratio in the present disclosure, to maintain a constant overall scaling ratio. The scaling ratio look-up table (i.e., a coordinate mapping table) records pixel coordinates before Grouping and pixel coordinates after Grouping, as well as pixel coordinates before Ungrouping and pixel coordinates after Ungrouping. The pixel coordinates before Grouping and the pixel coordinates after Grouping together with the pixel coordinates before Ungrouping and the pixel coordinates after Ungrouping form a continuous ratio scaling curve as illustrated in FIG. 9, so as to dynamically calculate a scaling ratio of each region when the gaze region moves.

The continuous ratio scaling curve adopts a derivative-smoothed curve. Taking a cubic polynomial curve as an example, correspondingly, a derivative thereof (quadratic polynomial curve) is a scaling ratio of corresponding coordinates, and the increase in the scaling ratio thereof is relatively stable. Interpolation weights are sampled from an interpolation curve (nearest, bilinear, Lanczos, etc.) according to the scaling ratio and blurring requirements, and coefficients of the polynomial are solved by setting a maximum scaling ratio, a minimum scaling ratio, and an overall scaling ratio as required.

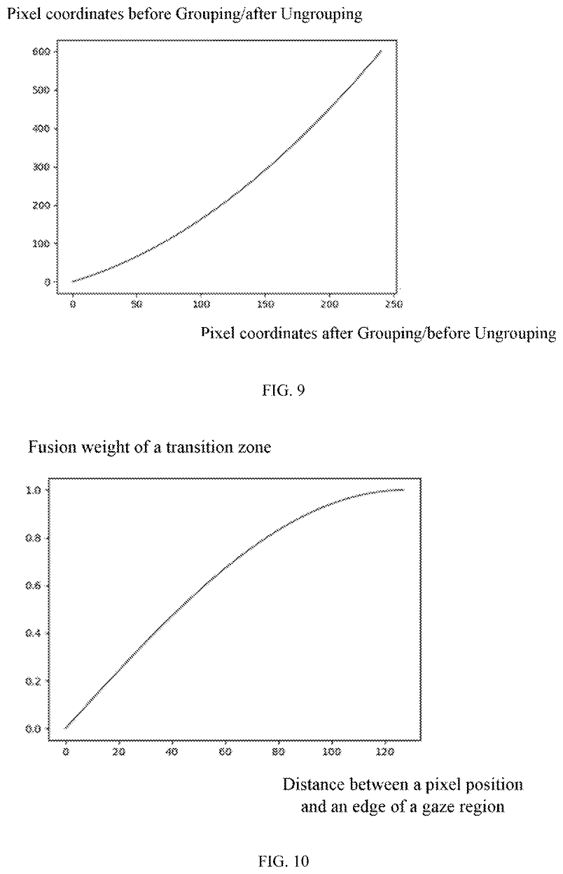

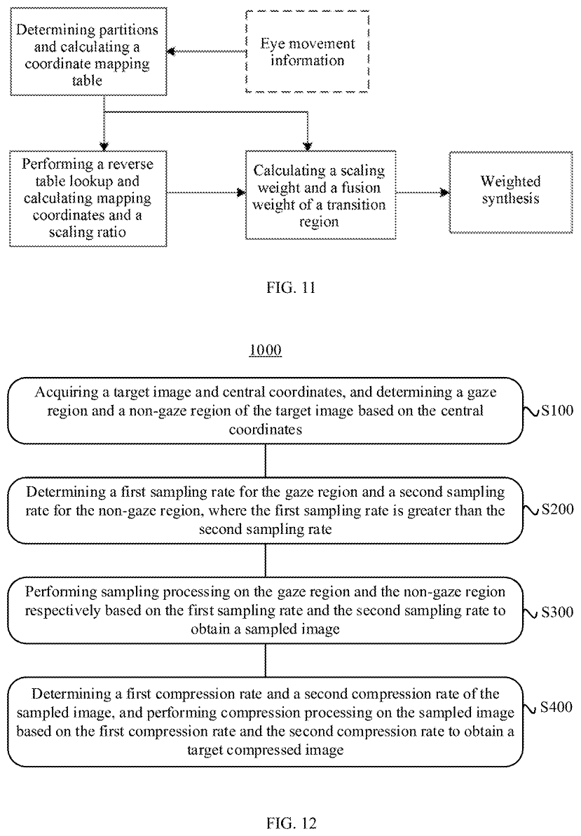

The fusion weight of the transition region and a distance between a pixel position and the edge of the gaze region form a transition zone curve shown in FIG. 10, i.e., a transition fusion weight curve. The transition zone curve renders a variation of the image smoother when the gaze region undergoes an identity transform. The transition zone curve is sampled from a sine curve according to a distance to a central region. Moreover, a Lanczos weight is larger at a position closer to an edge of a region of interest (the gaze region), while an identity weight increases toward a center of the region of interest.

“Transition fusion weight” on a vertical axis of the transition fusion weight curve integrates an interpolation curve weight and an identity mapping weight, thereby generating a transition zone weighted synthesis weight c, and a specific calculation formula is as follows:

$$c = b * w 1 + a * ( 1 - w 1 )$$

where b denotes the identity weight, a denotes the interpolation curve weight, and w1 denotes a transition fusion weight coefficient.

After the compressed target image is acquired based on the above embodiment, the computation needs be performed on the compressed target image to obtain the processed target image.

The computation performed on the compressed target image includes but is not limited to performing an NPU computation on the target image or processing on the target image by a unit, such as a digital signal processor (DSP), a central processing unit (CPU), a graphics processing unit (GPU), an application-specific integrated circuit (ASIC) and a storage (SRAM (Static Random-Access Memory)/DDR (Double Data Rate)/NAND (Not AND)), and the processing method herein is not specifically limited.

For example, the computation performed on the compressed target image is denoising the compressed target image, which mainly employs a neural network algorithm to perform denoising processing on the compressed target image, obtain the processed target image.

Subsequently, it is necessary to obtain the decompressed target image according to the central coordinates and the processed target image.

In conjunction with FIG. 11, to obtain the decompressed target image according to the central coordinates and the processed target image, main execution steps are as follows: first, calculating coordinates of respective regions in the processed target image according to the central coordinates; then, performing decompression processing on the processed target image based on the coordinates of the respective regions in the processed target image to obtain the decompressed target image. The central coordinates refer to a position corresponding to the gaze region of the target image.

The calculating coordinates of respective regions in the processed target image according to the central coordinates requires that: coordinates of respective regions in a non-gaze region of the processed target image are first determined according to the central coordinates, where the coordinates of the respective regions in the processed target image include the central coordinates and the coordinates of the respective regions in the non-gaze region.

The performing decompression processing on the processed target image based on the coordinates of the respective regions in the processed target image to obtain the decompressed target image requires that: a coordinate mapping table of the non-gaze region is first determined based on the coordinates of the respective regions in the non-gaze region of the processed target image; then, a reverse table lookup is performed according to the gaze region, the central coordinates, the non-gaze region, and the coordinate mapping table, and mapping coordinates and a scaling ratio of each pixel position in the processed target image are calculated; furthermore, a scaling weight of the gaze region, a scaling weight of the non-gaze region, and a fusion weight of a transition region in the processed target image are calculated based on the scaling ratio; and finally, weighted synthesis is performed on the scaling weight of the gaze region, the scaling weight of the non-gaze region, and the fusion weight of the transition region, and the decompressed target image is output.

Furthermore, the compressed target image may be input into an algorithm model, such as an ISP and an NPU, for further processing. The ISP is an image signal processing architecture that can run various algorithm programs and process image signals in real time. The ISP mainly includes devices such as a CPU, a SUB IP, and an IF (Interface), etc. The CPU, i.e., the central processing unit, can run various image processing algorithms such AF (Auto Focus) and LSC (Lens Shading Correction) and control a peripheral device. An internal CPU of a modern ISP is generally ARM Cortex-A series, for example, a Cortex-A5 and a Cortex-A7. The SUB IP is a general term for various functional modules, each of which performs specialized image processing on the image. A common SUB IP includes a DIS (Digital Image Stabilization), a CSC (Color Space Conversion), a VRA (Video Recognition Accelerator), etc. The NPU is a neural processing unit, which is a dedicated processor for neural network computation. A main function of the NPU is to accelerate the neural network computation, and the NPU can rapidly implement computational operations of a neural network such as data processing, transmission and backpropagation. A working principle of the NPU is based on a computational model of the neural network, with a core being an implementation of a deep learning algorithm. Generally speaking, the NPU achieves efficient computation by performing parallel processing on various computational operations in the neural network. In the neural network, neurons are connected through weights. During a training process, the NPU may continuously adjust these weights according to sample data, so that the neural network can ultimately achieve optimal recognition performance.

The embodiments of the present disclosure provide an image scaling processing method and an apparatus, a terminal and a storage medium, where the method includes: acquiring eye movement information generated when a user observes a target image, then performing a coordinate conversion on the eye movement information to obtain central coordinates corresponding to the eye movement information, determining a non-gaze region of the target image according to the central coordinates, and performing compression on the non-gaze region of the target image to obtain a compressed target image, performing a computation on the compressed target image to obtain a processed target image, and finally obtaining a decompressed target image according to the central coordinates and the processed target image. The present disclosure scales the non-gaze region based on the central coordinates, enabling a scaled image need to be rapidly restored to an original size after processing by the NPU. This ensures that other spatial domain-related modules of the ISP remain unaffected, prevents degradation of the target image quality, and enhances the scaling effect of the target image. In addition, the present disclosure mainly saves storage bandwidth and computing hardware resources through compression, effectively reducing hardware resource requirements while ensuring the image effect of the gaze point region. It should be understood that magnitude of sequence numbers of the steps in the above embodiments does not indicate priority of an execution order. The execution order of each process shall be determined based on a function and an inherent logic thereof, and shall not constitute any limitation on implementation processes of the embodiments of the present disclosure.

FIG. 12 is an implementation flowchart of an image scaling processing method 1000 provided by another embodiment of the present disclosure. As shown in FIG. 12, the image scaling processing method 1000 may include:
step S100: acquiring a target image and central coordinates, and determining, based on the central coordinates, a gaze region and a non-gaze region of the target image;
step S200: determining a first sampling rate for the gaze region and a second sampling rate for the non-gaze region, where the first sampling rate is greater than the second sampling rate;
step S300: performing sampling processing on the gaze region and the non-gaze region respectively based on the first sampling rate and the second sampling rate to obtain a sampled image; and
step S400: determining a first compression rate and a second compression rate of the sampled image, and performing compression processing on the sampled image based on the first compression rate and the second compression rate to obtain a target compressed image.

Specific contents of each step of the above-image scaling processing method 1000 will be elaborated below.

Step S100

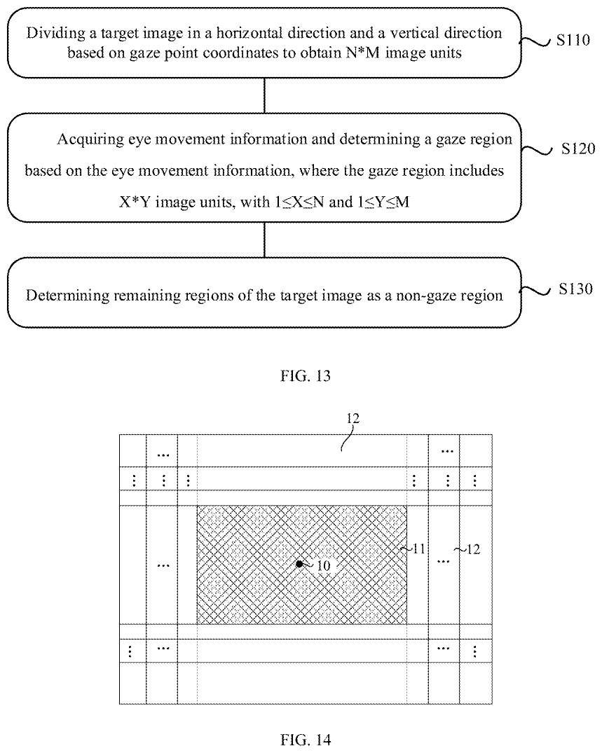

In an exemplary implementation of the present disclosure, first, the target image and the central coordinates are acquired, and the gaze region and the non-gaze region of the target image are determined based on the central coordinates. For example, the target image and the central coordinate may be acquired by an eye movement device. The central coordinates may be a position where eyes gaze in the target image. For example, the central coordinates may include gaze point coordinates, gaze point information may change accordingly with change of an eye gaze direction of a user, and the central coordinates will change accordingly. Subsequently, the target image is divided into the gaze region and the non-gaze region based on the gaze point information. FIG. 13 is an implementation flowchart of determining a gaze region and a non-gaze region of a target image provided by an embodiment of the present disclosure. As shown in FIG. 13, the determining a gaze region and a non-gaze region of a target image may include following steps:
step S110, dividing the target image in a horizontal direction and a vertical direction based on gaze point coordinates to obtain N*M image units;
step S120, acquiring eye movement information and determining the gaze region based on the eye movement information, where the gaze region includes X*Y image units, with 1≤X≤N and 1≤Y≤M; and
step S130, determining remaining regions of the target image as the non-gaze region.

FIG. 14 is a schematic diagram of a gaze region and a non-gaze region provided by an embodiment of the present disclosure. As shown in FIG. 14, a target image may include a gaze point 10, a gaze region 11, and a non-gaze region 12. First, division is performed in a horizontal direction and a vertical direction based on gaze point coordinates, to obtain N*M image units (not shown in the figure) by the division. Each image unit may have a same size, and an image unit in the present disclosure may be a pixel. Subsequently, eye movement information is acquired, and the gaze region is determined based on the eye movement information. The gaze region may include X*Y image units, where M, N, X, and Y are all positive integers, with 1≤X≤N and 1≤Y≤M. Remaining regions of the target image are determined as the non-gaze region 12.

Step S200

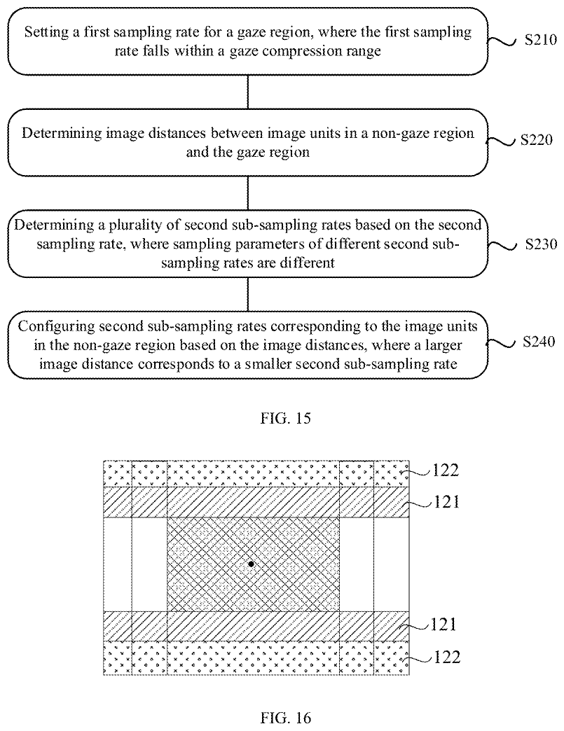

In an exemplary implementation of the present disclosure, after the gaze region and the non-gaze region are determined, the first sampling rate for the gaze region and the second sampling rate for the non-gaze region may further be determined, where the first sampling rate is greater than the second sampling rate. FIG. 15 is an implementation flowchart of determining a first sampling rate and a second sampling rate provided by an embodiment of the present disclosure. As shown in FIG. 15, the determining a first sampling rate and a second sampling rate may include following steps:
step S210: setting the first sampling rate for the gaze region, where the first sampling rate falls within a gaze compression range;
step S220: determining image distances between image units in the non-gaze region and the gaze region;
step S230: determining a plurality of second sub-sampling rates based on the second sampling rate, where sampling parameters of different second sub-sampling rates are different; and
step S240: configuring second sub-sampling rates corresponding to the image units in the non-gaze region based on the image distances, where a larger image distance corresponds to a smaller second sub-sampling rate.

For example, the first sampling rate for the gaze region is first set, where the first sampling rate falls within the gaze compression range. Since the eyes are sensitive to the image quality of the gaze region, the magnitude of the first sampling rate can be controlled by setting the gaze compression range, so as to further guarantee the imaging quality of the gaze region. Subsequently, a plurality of second sub-sampling rates may be set within the non-gaze region, where sampling parameters of the plurality of second sub-sampling rates are different. In the non-gaze region, sampling rates of image units located in a same horizontal direction are the same, and sampling rates of image units located in a same vertical direction are the same. FIG. 16 is a schematic diagram of configuring second sub-sampling rates for a non-gaze region provided by an embodiment of the present disclosure. As shown in FIG. 16, an example is given, where the gaze region is located at the center of the target image region, and the second sub-sampling rates are configured for the non-gaze region along the horizontal direction. The non-gaze region is divided according to the image distances between the image units in the non-gaze region and the gaze region. For example, a second sub-image region 121 and a second sub-image region 122 are divided out, where each of the second sub-image region 121 and the second sub-image region 122 may include a plurality of image units, and second sub-sampling rates are then configured for the second sub-image region 121 and the second sub-image region 122, where a second sub-sampling rate corresponding to the second sub-image region 121 is greater than a second sub-sampling rate corresponding to the second sub-image region 122.

Step S300

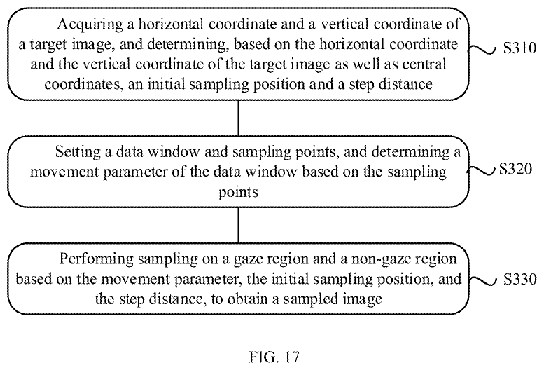

In an exemplary implementation of the present disclosure, after the first sampling rate and the second sampling rate are obtained, the sampling processing may be performed on the gaze region and the non-gaze region respectively based on the first sampling rate and the second sampling rate to obtain the sampled image. FIG. 17 is an implementation flowchart of performing sampling processing on a gaze region and a non-gaze region provided by an embodiment of the present disclosure. As shown in FIG. 17, the performing sampling processing on a gaze region and a non-gaze region may include following steps:
step S310: acquiring a horizontal coordinate and a vertical coordinate of the target image, and determining, based on the horizontal coordinate and the vertical coordinate of the target image as well as the central coordinates, an initial sampling position and a step distance;
step S320: setting a data window and sampling points, and determining a movement parameter of the data window based on the sampling points; and
step S330: performing sampling on the gaze region and the non-gaze region based on the movement parameter, the initial sampling position, and the step distance, obtain the sampled image.

For example, the initial sampling position and the step distance are determined according to the horizontal coordinate and the vertical coordinate of the target image as well as a position of the gaze point. Different sampling rates correspond to different step distances, where a higher sampling rate of an image region corresponds to a smaller step distance. For example, a corresponding initial sampling position and a corresponding step distance may be set based on the first sampling rate and the second sampling rate set for the gaze region and the non-gaze region respectively. The data window and the sampling points are set within the gaze region and the non-gaze region, and the movement parameter of the data window is determined by the set sampling points. The movement parameter of the data window includes a moving speed and a moving distance of the data window. By setting the sampling points and setting the movement parameter of the data window based on the sampling points, different sampling frequencies can be compatible within the same data window, thereby improving the flexibility and efficiency of sampling. Subsequently, the sampling is performed on the gaze region and the non-gaze region based on the movement parameter, the initial sampling position and the step distance, to obtain the sampled image. During a sampling process of the gaze region and the non-gaze region, a relative position between the data window and a first sampling point and/or a second sampling point may also be determined, and the movement parameter may be further determined based on the relative position. The first sampling point may be a current sampling point, and the second sampling point may be a next sampling point. For example, relative positions between the current sampling point, the next sampling point, and the data window may include that: (1) the current sampling point is outside the data window; (2) the current sampling point is inside the data window, while the next sampling point is outside the data window; (3) both the current sampling point and the next sampling point are inside the data window, but a distance between the current sampling point and the data window is greater than a distance threshold; (4) the next sampling point is located at a starting sampling position of a next row. If the current sampling point, the next sampling point, and the data window meet any one of the above-mentioned conditions of the relative positions, the data window needs to be moved by the step distance, after which a data window for a next moment is obtained, and then relative positions between a current sampling point, a next sampling point, and the data window at the next moment are determined again. If the current sampling point, the next sampling point, and the data window do not meet the above-mentioned conditions of the relative positions, the data window is not moved. The present disclosure optimizes the sampling process through the relative positions between the sampling points and the data window, which can, to some extent, avoid back-pressure on the preceding data stream and improve the operating performance of the sampling.

Step S400

In an exemplary implementation of the present disclosure, after the sampled image is obtained, the first compression rate and the second compression rate of the sampled image may further be determined, and the compression processing may be performed on the sampled image based on the first compression rate and the second compression rate, to obtain the target compressed image. For example, after the sampled image is obtained by performing sampling on the target image, different compression rates or different compression methods may further be set based on the gaze region and the non-gaze region of the sampled image. For example, the gaze region is compressed by means of lossless compression, while the non-gaze region is compressed by means of lossy compression. For example, the first compression rate is set for the gaze region, and the second compression rate is set for the non-gaze region, where the first compression rate is smaller than the second compression rate. A plurality of second sub-compression rates may be further set within the non-gaze region in the present disclosure. The second compression rate includes the plurality of second sub-compression rates, and the second sub-compression rates may be set based on the second sub-sampling rates. For example, the smaller the second sub-sampling rate, the larger the second sub-compression rate. After the first compression rate and the second compression rate are set, the compression processing may further be performed on the sampled image based on the first compression rate and the second compression rate, to obtain the target compressed image.

According to the exemplary implementation of the present disclosure, by dividing the target image into the gaze region and the non-gaze region, and setting the sampling rate of the gaze region to be higher than the sampling rate of the non-gaze region, and the compression rate of the gaze region to be lower than the compression rate of the non-gaze region, the size of the compressed image can be reduced while ensuring the image quality, effectively saving storage resources.

In an exemplary implementation of the present disclosure, after the target compressed image is obtained, the target compressed image may further be transmitted, stored, and decompressed. For example, the target compressed image may be stored and/or decompressed based on the first compression rate and the second compression rate, and an output image is obtained, where the output image may be the sampled image. In the present disclosure, restoration processing may be further performed on the sampled image based on the first sampling rate and the second sampling rate to obtain the target image. The image scaling processing methods provided in the embodiments of the present disclosure may be applied to a chip, or a head-mounted display (for example, smart glasses) configured to implement virtual reality (VR), augmented reality (AR), and/or mixed reality (MR), which is not specifically limited in the present disclosure. The following are apparatus embodiments of the present disclosure. For details not described in detail therein, reference may be made to the corresponding method embodiments described above.

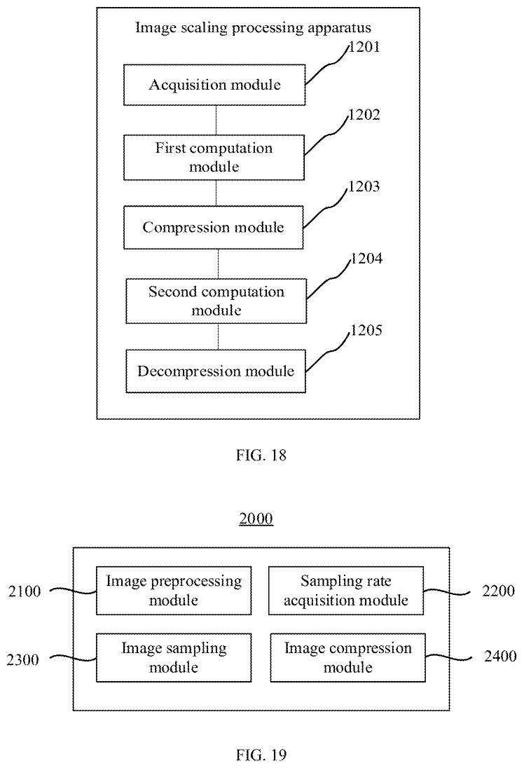

FIG. 18 is a schematic structural diagram of an image scaling processing apparatus provided by an embodiment of the present disclosure. For ease of explanation, only the parts related to the embodiments of the present disclosure are shown. An image scaling processing apparatus includes an acquisition module 1201, a first computation module 1202, a compression module 1203, a second computation module 1204, and a decompression module 1205, as detailed below:
the acquisition module 1201 is configured to acquire eye movement information generated when a user observes a target image;
the first computation module 1202 is configured to perform a coordinate conversion on the eye movement information to obtain central coordinates corresponding to the eye movement information;
the compression module 1203 is configured to determine a non-gaze region of the target image according to the central coordinates, and perform compression on the non-gaze region of the target image to obtain a compressed target image;
the second computation module 1204 is configured to perform a computation on the compressed target image to obtain a processed target image; and
the decompression module 1205 is configured to obtain a decompressed target image according to the central coordinates and the processed target image.

In a possible implementation, the compression module 1203 is further configured to determine coordinates of respective regions in the non-gaze region of the target image according to the central coordinate, where coordinates of respective regions in the target image include the central coordinates and the coordinates of the respective regions in the non-gaze region; and perform compression processing on the target image based on the coordinates of the respective regions in the target image to obtain the compressed target image.

In a possible implementation, the compression module 1203 is further configured to determine a coordinate mapping table of the non-gaze region based on the coordinates of the respective regions in the non-gaze region of the target image;
perform a table lookup according to the gaze region, the central coordinates, the non-gaze region, and the coordinate mapping table, and calculate mapping coordinates and a scaling ratio of each pixel point position in the target image;
calculate, according to the scaling ratio, a scaling weight of the gaze region, a scaling weight of the non-gaze region, and a fusion weight of a transition region in the target image, where a continuous ratio scaling curve corresponding to the scaling weight of the non-gaze region is a first derivative-smoothed curve, a point on the first derivative-smoothed curve is used to represent a scaling ratio at a pixel coordinate position, and the scaling ratio increases progressively;
a transition fusion weight curve corresponding to the fusion weight is a second derivative-smoothed curve, a point on the second derivative-smoothed curve is used to represent a transition fusion weight of a distance between a pixel position and an edge of the gaze region, the transition fusion weight integrates an interpolation curve weight and an identity mapping weight, and an interpolation curve weight of a pixel position close to an edge position of the gaze region is higher, while an identity mapping weight of a pixel position close to a center of the gaze region is higher; and
perform weighted synthesis on the scaling weight of the gaze region, the scaling weight of the non-gaze region, and the fusion weight of the transition region, and output the compressed target image.

In a possible implementation, an image algorithm operation used for computation processing performed on the compressed target image includes at least one of: an operation of a denoising algorithm, or a specific image algorithm operation.

In a possible implementation, the denoising algorithm is a neural network algorithm;
the decompression module is further configured to perform denoising processing on the compressed target image by using the neural network algorithm to obtain the processed target image.

In a possible implementation, the decompression module 1205 is further configured to calculate coordinates of respective regions in the processed target image according to the central coordinates;
perform decompression processing on the processed target image based on the coordinates of the respective regions in the processed target image to obtain the decompressed target image.

In a possible implementation, the central coordinates refer to a position corresponding to the gaze region of the target image;
the decompression module 1205 is further configured to determine coordinates of respective regions in a non-gaze region of the processed target image according to the central coordinates, where the coordinates of the respective regions in the processed target image include the central coordinates and the coordinates of the respective regions in the non-gaze region.

In a possible implementation, the decompression module 1205 is further configured to determine a coordinate mapping table of the non-gaze region based on the coordinates of the respective regions in the non-gaze region of the processed target image;
perform a reverse table lookup according to the gaze region, the central coordinates, the non-gaze region, and the coordinate mapping table, and calculate mapping coordinates and a scaling ratio of each pixel point position in the processed target image;
calculate, according to the scaling ratio, a scaling weight of the gaze region, a scaling weight of the non-gaze region, and a fusion weight of a transition region in the processed target image; and
perform weighted synthesis on the scaling weight of the gaze region, the scaling weight of the non-gaze region, and the fusion weight of the transition region, and output the decompressed target image.

In a possible implementation, the central coordinates refer to a position corresponding to the gaze region of the target image or a position corresponding to a gaze point set on the target image.

In a possible implementation, the gaze point is dynamic information obtained according to eye tracking, or a static gaze point unaffected by the eye movement information.

In a possible implementation, the target image includes at least one of: a Bayer image, an RGB image, a RAW image, or a YUV image.

In a possible implementation, a computation method for performing the computation on the compressed target image includes at least one of: NPU computation, or neural network model computation.

The present disclosure further provides an image scaling processing apparatus. FIG. 19 is a block diagram of an image scaling processing apparatus 2000 according to an exemplary implementation of the present disclosure. As shown in FIG. 19, the image scaling processing apparatus 2000 may include an image preprocessing module 2100, a sampling rate acquisition module 2200, an image sampling module 2300, and an image compression module 2400.

In an exemplary implementation of the present disclosure, the image preprocessing module 2100 may be configured to acquire a target image and central coordinates, and determine a gaze region and a non-gaze region of the target image based on the central coordinates.

For example, the image preprocessing module 2100 may be configured to divide the target image in a horizontal direction and a vertical direction based on gaze point coordinates to obtain N*M image units; acquire eye movement information and determine the gaze region based on the eye movement information, where the gaze region includes X*Y image units, with 1≤X≤N and 1≤Y≤M; and determine remaining regions of the target image as the non-gaze region.

In an exemplary implementation of the present disclosure, the sampling rate acquisition module 2200 may be configured to determine a first sampling rate for the gaze region and a second sampling rate for the non-gaze region, where the first sampling rate is greater than the second sampling rate.

For example, the sampling rate acquisition module 2200 may be configured to set the first sampling rate for the gaze region, where the first sampling rate falls within a gaze compression range; determine image distances between image units in the non-gaze region and the gaze region; determine a plurality of second sub-sampling rates based on the second sampling rate, where sampling parameters of different second sub-sampling rates are different; and configure second sub-sampling rates corresponding to the image units in the non-gaze region based on the image distances, where a larger image distance corresponds to a smaller second sub-sampling rate. In the non-gaze region, sampling rates of image units located in a same horizontal direction are the same, and sampling rates of image units located in a same vertical direction are the same.

In an exemplary implementation of the present disclosure, the image sampling module 2300 may be configured to perform sampling processing on the gaze region and the non-gaze region respectively based on the first sampling rate and the second sampling rate to obtain a sampled image.

For example, the image sampling module 2300 may be configured to acquire a horizontal coordinate and a vertical coordinate of the target image, and determine, based on the horizontal coordinate and the vertical coordinate of the target image as well as the central coordinates, an initial sampling position and a step distance; set a data window and sampling points, and determine a movement parameter of the data window based on the sampling points; and perform sampling on the gaze region and the non-gaze region based on the movement parameter, the initial sampling position, and the step distance, to obtain the sampled image.

In an exemplary implementation of the present disclosure, the image compression module 2400 may be configured to determine a first compression rate and a second compression rate of the sampled image, and perform compression processing on the sampled image based on the first compression rate and the second compression rate to obtain a target compressed image.

In an exemplary implementation of the present disclosure, the image scaling processing apparatus 2000 further includes: a storage unit, which may be configured to store the target compressed image; and a decompression unit, which may be configured to acquire the target compressed image from the storage unit, and perform storage and/or decompression processing on the target compressed image to obtain an output image.

Functions and roles of respective modules of the image scaling processing apparatus 2000 in the present disclosure have been specifically described in the respective steps of the image scaling processing method 1000, and will not be elaborated further herein.

According to the exemplary implementation of the present disclosure, by dividing the target image into the gaze region and the non-gaze region, and setting the sampling rate of the gaze region to be higher than the sampling rate of the non-gaze region, and the compression rate of the gaze region to be lower than the compression rate of the non-gaze region, the size of the compressed image can be reduced while ensuring the image quality, effectively saving storage resources.

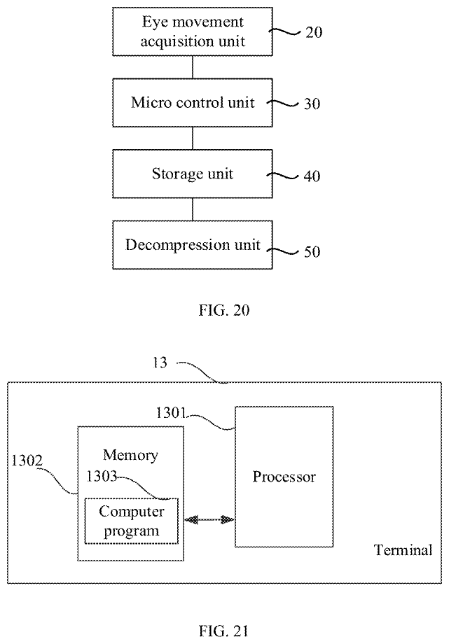

The present disclosure further provides an image scaling processing apparatus. FIG. 20 is a block diagram of an image scaling processing apparatus according to an exemplary implementation of the present disclosure. As shown in FIG. 20, the image scaling processing apparatus may include an eye movement acquisition unit 20, a micro control unit 30, a storage unit 40 and a decompression unit 50. The eye movement acquisition unit 20 may be configured to acquire a target image and central coordinates based on an eye movement device, and determine a gaze region and a non-gaze region of the target image based on the central coordinates; the micro control unit 30 may be configured to acquire corresponding coordinate points based on the gaze region and the non-gaze region, and perform compression processing on the gaze region and the non-gaze region based on the coordinate points to obtain a target compressed image; the storage unit 40 may be configured to store the target compressed image; and the decompression unit 50 may be configured to acquire the target compressed image from the storage unit 40, and perform storage and/or decompression processing on the target compressed image to obtain an output image.

Functions and roles of respective units of the image scaling processing apparatus in the present disclosure have been specifically described in the respective steps of the image scaling processing method 1000, and will not be elaborated further herein. FIG. 21 is a schematic diagram of a terminal provided by an embodiment of the present disclosure. As shown in FIG. 21, a terminal 13 of this embodiment includes: a processor 1301, a memory 1302, and a computer program 1303 stored in the memory 1302 and executable on the processor 1301.When the processor 1301 executes the computer program 1303, the steps in each of the above embodiments of the image scaling processing method are implemented. Alternatively, when the processor 1301 executes the computer program 1303, functions of each module/unit in each of the above embodiments of the image scaling processing apparatus are implemented.

The present disclosure further provides a readable storage medium, the readable storage medium having a computer program stored therein. The computer program, when executed by a processor, is used to implement the image scaling processing method provided by the various embodiments described above.

The readable storage medium may be a computer storage medium or a communication medium. The communication medium includes any medium that facilitates the transfer of a computer program from one place to another. The computer storage medium may be any available medium that can be accessed by a general-purpose or special-purpose computer. For example, the readable storage medium is coupled to the processor, such that the processor can read information from and write information to the readable storage medium. Certainly, the readable storage medium may also be an integral part of the processor. The processor and the readable storage medium may be located in an application specific integrated circuit (ASIC). Additionally, the ASIC may be located in user equipment. Certainly, the processor and the readable storage medium may also exist as discrete components in a communication device. The readable storage medium may be a read-only memory (ROM), a random-access memory (RAM), a compact disc read-only memory (CD-ROM), a magnetic tape, a floppy disk, an optical data storage device, etc.

The present disclosure further provides a program product, the program product including an execution instruction stored in a readable storage medium. At least one processor of a device may read the execution instruction from the readable storage medium, and at least one processor executes the execution instruction to enable the device to implement the image scaling processing method provided by the various embodiments described above.

The present disclosure further provides a computer program, the computer program is stored in a readable storage medium. At least one processor of an electronic device may read the computer program from the readable storage medium, and at least one processor executes the computer program to enable the electronic device to implement the image scaling processing method provided by the various embodiments described above.

In the above device embodiments, it should be understood that the processor may be a central processing unit (CPU), or other general-purpose processors, digital signal processors (DSPs), application specific integrated circuits (ASICs), etc. A general-purpose processor may be a microprocessor, or the processor may be any conventional processor. The steps of the method disclosed in the present disclosure may be directly embodied as being executed by a hardware processor, or executed by a combination of hardware and software modules in the processor.

The above embodiments are only intended to illustrate the technical solutions of the present disclosure, rather than to limit them. Although the present disclosure has been described in detail with reference to the foregoing embodiments, persons of ordinary skill in the art should understand that: they may still modify the technical solutions recited in the foregoing embodiments, or make equivalent substitutions for some of the technical features therein; and such modifications or substitutions do not cause the essence of the corresponding technical solutions to deviate from the spirit and scope of the technical solutions of the embodiments in the present disclosure, and all shall fall within the protection scope of the present disclosure.

What is claimed is:

1. An image scaling processing method, comprising:
acquiring eye movement information generated when a user observes a target image;
performing a coordinate conversion on the eye movement information to obtain central coordinates corresponding to the eye movement information;
determining a non-gaze region of the target image according to the central coordinates, and performing compression on the non-gaze region of the target image to obtain a compressed target image;
performing computation processing on the compressed target image to obtain a processed target image; and
obtaining a decompressed target image according to the central coordinates and the processed target image.

2. The image scaling processing method according to claim 1, wherein the determining a non-gaze region of the target image according to the central coordinates, and performing compression on the non-gaze region of the target image to obtain a compressed target image comprises:
determining coordinates of respective regions in the non-gaze region of the target image according to the central coordinates, wherein coordinates of respective regions in the target image comprise the central coordinates and the coordinates of the respective regions in the non-gaze region; and
performing compression processing on the target image based on the coordinates of the respective regions in the target image to obtain the compressed target image.

3. The image scaling processing method according to claim 2, wherein the target image further comprises a gaze region, and the method further comprises:
determining coordinates of respective regions in the gaze region of the target image according to the central coordinates, wherein the coordinates of the respective regions in the target image further comprise the coordinates of the respective regions in the gaze region, and the gaze region comprises a transition region located at an edge; and
performing compression processing on the target image based on the coordinates of the respective regions in the target image to obtain the compressed target image.

4. The image scaling processing method according to claim 3, wherein the performing compression processing on the target image based on the coordinates of the respective regions in the target image to obtain the compressed target image comprises:
determining a coordinate mapping table of the non-gaze region based on the coordinates of the respective regions in the non-gaze region of the target image;
performing a table lookup according to the gaze region, the central coordinates, the non-gaze region, and the coordinate mapping table, and calculating mapping coordinates and a scaling ratio of each pixel point position in the target image;
calculating, according to the scaling ratio, a scaling weight of the gaze region, a scaling weight of the non-gaze region, and a fusion weight of the transition region in the target image; and
performing weighted synthesis on the scaling weight of the gaze region, the scaling weight of the non-gaze region, and the fusion weight of the transition region, and outputting the compressed target image.

5. The image scaling processing method according to claim 4, wherein a continuous ratio scaling curve corresponding to the scaling weight of the non-gaze region is a first derivative-smoothed curve, a point on the first derivative-smoothed curve is used to represent a scaling ratio at a pixel coordinate position, and the scaling ratio increases progressively;
wherein a transition fusion weight curve corresponding to the fusion weight is a second derivative-smoothed curve, a point on the second derivative-smoothed curve is used to represent a transition fusion weight of a distance between a pixel position and the edge of the gaze region, the transition fusion weight integrates an interpolation curve weight and an identity mapping weight, and an interpolation curve weight of a pixel position close to an edge position of the gaze region is higher, while an identity mapping weight of a pixel position close to a center of the gaze region is higher.

6. The image scaling processing method according to claim 1, wherein an image algorithm operation used for the computation processing performed on the compressed target image comprises at least one of: an operation of a denoising algorithm, or a specific image algorithm operation.

7. The image scaling processing method according to claim 6, wherein the denoising algorithm is a neural network algorithm;
the performing computation processing on the compressed target image to obtain a processed target image comprises:
performing denoising processing on the compressed target image by using the neural network algorithm to obtain the processed target image.

8. The image scaling processing method according to claim 1, wherein the obtaining a decompressed target image according to the central coordinates and the processed target image comprises:
calculating coordinates of respective regions in the processed target image according to the central coordinates; and
performing decompression processing on the processed target image based on the coordinates of the respective regions in the processed target image to obtain the decompressed target image.

9. The image scaling processing method according to claim 8, wherein the central coordinates refer to a position corresponding to a gaze region of the target image;
the calculating coordinates of respective regions in the processed target image according to the central coordinates comprises:
determining coordinates of respective regions in a non-gaze region of the processed target image according to the central coordinates, wherein the coordinates of the respective regions in the processed target image comprise the central coordinates and the coordinates of the respective regions in the non-gaze region.

10. The image scaling processing method according to claim 9, wherein the performing decompression processing on the processed target image based on the coordinates of the respective regions in the processed target image to obtain the decompressed target image comprises:
determining a coordinate mapping table of the non-gaze region based on the coordinates of the respective regions in the non-gaze region of the processed target image;
performing a reverse table lookup according to the gaze region, the central coordinates, the non-gaze region, and the coordinate mapping table, and calculating mapping coordinates and a scaling ratio of each pixel point position in the processed target image;
calculating, according to the scaling ratio, a scaling weight of a gaze region, a scaling weight of the non-gaze region, and a fusion weight of a transition region in the processed target image; and
performing weighted synthesis on the scaling weight of the gaze region, the scaling weight of the non-gaze region, and the fusion weight of the transition region, and outputting the decompressed target image.

11. The image scaling processing method according to claim 1, wherein:
the central coordinates refer to a position corresponding to a gaze region of the target image or a position corresponding to a gaze point set on the target image, wherein the gaze point is dynamic information obtained according to eye tracking, or a static gaze point unaffected by the eye movement information; and
a computation method for performing the computation processing on the compressed target image comprises at least one of: neural processing unit (NPU) computation, or neural network model computation.

12. The image scaling processing method according to claim 1, wherein the target image further comprises a gaze region, and the method further comprises:
determining, according to the central coordinates, the gaze region and the non-gaze region of the target image;
determining a first sampling rate for the gaze region and a second sampling rate for the non-gaze region, wherein the first sampling rate is greater than the second sampling rate;
performing sampling processing on the gaze region and the non-gaze region respectively based on the first sampling rate and the second sampling rate to obtain a sampled image; and
determining a first compression rate and a second compression rate of the sampled image, and performing compression processing on the gaze region and the non-gaze region of the sampled image based on the first compression rate and the second compression rate to obtain a target compressed image.

13. The image scaling processing method according to claim 12, wherein the determining, according to the central coordinates, the gaze region and the non-gaze region of the target image comprises:
dividing the target image in a horizontal direction and a vertical direction based on the central coordinates to obtain N*M image units;
determining the gaze region based on the central coordinates, wherein the gaze region comprises X*Y image units, with 1≤X≤N and 1≤Y≤M; and
determining remaining regions of the target image as the non-gaze region.

14. The image scaling processing method according to claim 13, wherein the performing sampling processing on the gaze region and the non-gaze region respectively based on the first sampling rate and the second sampling rate to obtain a sampled image comprises:
acquiring a horizontal coordinate and a vertical coordinate of the target image, and determining, based on the horizontal coordinate and the vertical coordinate of the target image as well as the central coordinates, an initial sampling position and a step distance;
setting a data window and sampling points, and determining a movement parameter of the data window based on the sampling points; and
performing sampling on the gaze region and the non-gaze region based on the movement parameter, the initial sampling position, and the step distance, to obtain the sampled image.

15. The image scaling processing method according to claim 14, wherein the setting a data window and sampling points, and determining a movement parameter of the data window based on the sampling points comprises:
determining a relative position of the data window and at least one of a first sampling point or a second sampling point; and
determining the movement parameter based on the relative position.

16. The image scaling processing method according to claim 13, wherein in the non-gaze region, sampling rates of image units located in the same horizontal direction are the same, and sampling rates of image units located in the same vertical direction are the same.

17. The image scaling processing method according to claim 12, wherein the determining a first sampling rate for the gaze region and a second sampling rate for the non-gaze region comprises:
setting the first sampling rate for the gaze region, wherein the first sampling rate falls within a gaze compression range;
determining image distances between image units in the non-gaze region and the gaze region;
determining a plurality of second sub-sampling rates based on the second sampling rate, wherein sampling parameters of different second sub-sampling rates are different; and
configuring second sub-sampling rates corresponding to the image units in the non-gaze region based on the image distances, wherein a larger image distance corresponds to a smaller second sub-sampling rate.

18. The image scaling processing method according to claim 12, wherein the method further comprises:
performing at least one of storage processing or decompression processing on the target compressed image based on the first compression rate and the second compression rate to obtain an output image.

19. An image scaling processing apparatus, comprising:
a memory, a processor, and a computer program stored in the memory and executable on the processor, wherein when the computer program is executed by the processor, following steps are implemented:
acquiring eye movement information generated when a user observes a target image;
performing a coordinate conversion on the eye movement information to obtain central coordinates corresponding to the eye movement information;
determining a non-gaze region of the target image according to the central coordinates, and performing compression on the non-gaze region of the target image to obtain a compressed target image;
performing a computation on the compressed target image to obtain a processed target image; and
obtaining a decompressed target image according to the central coordinates and the processed target image.

20. A non-transitory computer-readable storage medium, the non-transitory computer-readable storage medium storing a computer program, wherein when the computer program is executed by a processor, following steps are implemented:
acquiring eye movement information generated when a user observes a target image;
performing a coordinate conversion on the eye movement information to obtain central coordinates corresponding to the eye movement information;
determining a non-gaze region of the target image according to the central coordinates, and performing compression on the non-gaze region of the target image to obtain a compressed target image;
performing computation processing on the compressed target image to obtain a processed target image; and
obtaining a decompressed target image according to the central coordinates and the processed target image.
